(19) United States
(12) Patent Application Publication
(10) Pub. No.: US 2015/0252294 A1
(43) Pub. Date: Sep. 10, 2015

(54) HIGH ACTIVE FLOWABLE SURFACTANT BLENDS FOR DETERGENT AND OTHER CLEANING APPLICATIONS

(71) Applicant: Board of Regents, The University of Texas System, Austin, TX (US)

(72) Inventors: Upali P. Weerasooriya, Austin, TX (US); Gary A. Pope, Cedar Park, TX (US); Gayani W.P. Pinnawala-Arachchilage, Katy, TX (US); Gayani Weerasooriya Kennedy, Austin, TX (US); Pathma Jith Liyanage, Austin, TX (US)

(21) Appl. No.: 14/640,883

(22) Filed: Mar. 6, 2015

Related U.S. Application Data
(60) Provisional application No. 61/950,581, filed on Mar. 10, 2014.

(51) Int. Cl. C11D 1/74; C11D 1/29; C11D 1/22

(52) U.S. Cl. CPC C11D 1/74; C11D 1/22; C11D 1/29

(57) ABSTRACT

The present invention includes compositions and methods for making and using a neat or high active fluid detergent composition comprising: at least one of a neat carboxylate, a neat sulfonate, or a neat sulfate heated to 30° C. or greater, wherein the neat carboxylate (or acid thereof), the neat sulfonate (or acid thereof), or the neat sulfate (or acid thereof) is a solid or a viscous liquid at ambient temperature; a surfactant mixed with the neat carboxylate, neat sulfonate, or neat sulfate, wherein when the mixed composition is reduced to 5° C. to 40° C. it is flowable; and one or more ingredients selected from at least one of one or more buffers, salts, etc.

### CROSS-REFERENCE TO RELATED APPLICATIONS

This application claims benefit of U.S. Provisional Application Ser. No. 61/950,581 filed Mar. 10, 2014 which is incorporated herein by reference in its entirety.

### TECHNICAL FIELD OF THE INVENTION

The present invention relates in general to the field of detergents, and more particularly, to compositions and methods of making high active flowable surfactant detergent blends.

### STATEMENT OF FEDERALLY FUNDED RESEARCH

None.

### BACKGROUND OF THE INVENTION

Without limiting the scope of the invention, its background is described in connection with surfactants.

One such detergent is taught in U.S. Pat. No. 6,537,960, issued to Ruhr, et al., directed to a surfactant blend for use in highly alkaline compositions. Briefly, these inventors are said to teach a low foaming surfactant blend for use in highly alkaline conditions including at least one C₃ to C₁₀ alkyl polyglucoside, at least one amine oxide, at least one polycarboxylated alcohol alkoxylate, and at least one alcohol alkoxylate. The blend may also combined with other optional ingredients including a source of alkalinity, water conditioning agents, a source of chlorine, silicates, solvents, high foam amine oxides, other surfactants, and so forth to form a cleaning concentrate, and may be diluted to use solutions with water.

Another such detergent is taught in United States Patent Application Publication No. 2012/0058266, filed by Chambers, et al., directed to the manufacture of high active detergent particles. Briefly, the application is said to teach a process for manufacturing detergent particles comprising the steps of: a) forming a liquid surfactant blend comprising a major amount of surfactant and a minor amount of water, the surfactant part consisting of at least 51 wt % linear alkylbenzenesulfonate and at least one co-surfactant, the surfactant blend consisting of at most 20 wt % nonionic surfactant; b) drying the liquid surfactant blend of step (a) in an evaporator or drier to a moisture content of at most 2 wt % and cooling the output from the evaporator or dryer; c) feeding the cooled material, which output comprises at least 93 wt % surfactant blend with a major part of LAS, to an extruder, optionally along with less than 10 wt % of other materials such as perfume, fluorescer, and extruding the surfactant blend to form an extrudate while periodically cutting the extrudate to form hard detergent particles with a diameter across the extruder of greater than 2 mm and a thickness along the axis of the extruder of greater than 0.2 mm, provided that the diameter is greater than the thickness; d) optionally, coating the extruded hard detergent particles with up to 30 wt % coating material selected from powdered inorganic material and mixtures of such material and nonionic material with a melting point in the range 40 to 90° C.

### SUMMARY OF THE INVENTION

In one embodiment the present invention includes a neat fluid detergent composition comprising: at least one of a neat carboxylate, a neat sulfonate, or a neat sulfate heated to 30° C. or greater, wherein the neat carboxylate (or acid thereof), the neat sulfonate (or acid thereof), or the neat sulfate (or acid thereof) is a solid or a viscous liquid at ambient temperature; a surfactant mixed with the neat carboxylate, neat sulfonate, or neat sulfate, wherein when the mixed composition is reduced to 5° C. to 40° C. it is flowable; and one or more ingredients selected from at least one of one or more buffers, salts, corrosion protecting agents, organic solvents, enzymes, enzyme stabilizers, grease cleaning polymers, clay soil cleaning polymers, soil release polymers, soil suspending polymers, bleaching compounds, brighteners, dyes, particulates, perfume, odor control agents, hydrotropes, foam suppressors, fabric care agents, pH adjusting agents, dye transfer inhibiting agents, preservatives, synthetic detergents, organic extracts, or non-fabric dyes. In one aspect, the enzyme is selected from at least one of proteases, amylases, cellulases, or lipases. In another aspect, the composition further comprises at least one of antibiotic agents, antifungal agents, antihelminthic agents, preservatives, anti-viral agents, anti-tarnish agents, pigments, dyes, fillers, germicides, hydrotropes, anti-oxidants, pro-perfumes, aldehydes, ketones, esters and alcohols, carriers, processing aids, solvents, anti-abrasion agents, cationic surfactants, amphoteric surfactants, zwitterionic surfactants, thixotropic agents, or thickeners. In another aspect, the synthetic detergent is selected from at least one of arachidic, behenic, caproleic, dodecenoic, eicosenoic, erucic, lauric, myristic, octadecenoic, oleic, palmitic, stearic, or tetradecenoic acids or salts thereof. In another aspect, the one or more enzyme stabilizer is selected from at least one of boric acid, calcium, short chain carboxylic acids, fructose, glucose, polyhydroxyl compounds, propylene glycol, sorbitol, or sucrose. In another aspect, the composition further comprises a base in an amount sufficient to bring the composition to a pH of 9 to 10 to ensure the stability of ether sulfate surfactants. In another aspect, the composition has less than 0.5, 1, 2, 3, 4, 5, 6, 7, 8, 9, 10%, 15%, 20%, 25%, 30%, 35%, 40%, 45%, or 50% water per volume. In another aspect, the composition dissolves in water in less than 5, 10, 15, 20, 30, 45, 50, 60 minutes, or 1, 2, 3, 4, 5, 6, 7, 8, 9, 10, 11, 12 hours at ambient temperature. In another aspect, the composition further comprises a co-solvent including water. In another aspect, the co-solvent is at least one of Phenol-2EO, phenol1-20EOethoxylates, C₁₋₄ phenol 1-20EO ethoxylates, C₁₋₆ linear or branched alcohols, C₁₋₆ linear or branched 0-5PO 1-20EO alkoxyalcohols, isobutanol 1-20 EO ethoxylates, amine 1-20EO ethoxylates, or C₁₋₆ alkyl amine 1-20EO ethoxylates. In another aspect, the co-solvent serves as the medium for neutralizing sulfonate or sulfate produced in the acidic form, thereby eliminating the need to a high concentration of water to neutralize and keep the neutralized surfactant flowable. In another aspect, the composition does not go through a gel-phase when dissolving in water. In another aspect, the base is at least one of NaOH, KOH, NH₄OH, Na₂CO₃, NaHCO₃, K₂CO₃, KHCO₃, Ca(OH)₂, Mg(OH)₂, Na acetate, K acetate, or NH₄acetate. In another aspect, the base is at between about 0%, 1%, 2%, 3%, 4%, 5%, 6%, 7%, 8% volume based upon volume of the composition. In another aspect, the carboxylate is at least one of a C₂₈-25PO-45EO-carboxylate, other C₁₂₋₃₂2-50PO2-100EO carboxylates, C₁₂₋₃₂ 2-50PO carboxylates C₈₋₂₈2-100EO carboxylates, C₈₋₁₈ carboxylates, trystyrylphenol (TSP) 2-50PO2-100EO carboxylate, Coco amidopropylbetain, other C₁₂₋₂₀ betains or sultains. In another aspect, the sulfate is at least one of TSP-35PO-20EO sulfate or other mono-, di-, and trialkylphenolalkoxysulfates, C₁₃-13PO-Sulfate, C₁₀₋₁₂-2.5EO-Sulfate, other C₈₋₃₂2-50PO 2-100EO sulfates, C₈₋₃₂ 2-50PO sulfates, or C₈₋₁₈ 2-100EO sulfates. In another aspect, the sulfonate is dodecylbenzenesulfonic acid or sulfonate, C₁₀₋₂₀ alkylbenzenesulfonic acid or sulfonate, olefin sulfonate such as C₁₂₋₃₀ internal olefin sulfonates (IOS), C₁₂₋₂₀ alpha-olefin sulfonates (AOS), C₁₂₋₂₈ glycerol sulfonates, C₁₂₋₂₈ diphenyloxidedisulfonate. In another aspect, the surfactant is at least one of C₁₅₋₁₇ alkyl benzene sulfonic acid, C₁₅₋₁₈ internal olefin sulfonate, C₁₀₋₂₃ internal olefin sulfonate, C₁₀₋₂₈internal olefin sulfonate, or C₁₂₋₂₀ alpha-olefin sulfonates. In another aspect, the neat carboxylate, sulfonate or sulfate is at between 15% volume and 75%, 20% to 70%, 30% to 60%, 40% to 50%, 15%, 16%, 17%, 18%, 19%, 20%, 25%, 30%, 35%, 40%, 45%, 50%, 55%, 60%, 65%, or 70% volume based upon total volume of the composition. In another aspect, the composition has a viscosity at 25° C. of between at least one of <300 to 10,500 at 100s−1, 400 and 10,000, 500 to 9,500, 600 to 9,000, 700 to 8,000, 800 to 7,000, 900 to 6,000, 1,000 to 5,000, 1,500 to 4,500, 2,000 to 4,000, or about 300, 321, 350, 375, 400, 450, 500, 600, 700, 750, 800, 900, 1,000, 1,100, 1,200, 1,300, 1,400, 1,500, 1,600, 1,700, 1,800, 1,900, 2,000, 2,500, 3,000, 4,000, 4,500, 5,000, 5,500, 6,000, 7,000, 8,000, 9,000, 10,000, or 10,500.

In another embodiment the present invention includes a method of making a high active or neat, flowable surfactant composition for use in enhanced oil recovery, detergent and other cleaning applications comprising the steps of: mixing with a surfactant at least one of a neat carboxylate, a neat sulfonate (or acid thereof), or a neat sulfate, wherein the components are solid or viscous at ambient temperature; heating the mixture to 30° C. or greater to form the mixture, wherein when the mixture is at 5° C. to 40° C. it is flowable; and adding one or more ingredients selected from at least one of one or more buffers, salts, corrosion protecting agents, organic solvents, enzymes, enzyme stabilizers, grease cleaning polymers, clay soil cleaning polymers, soil release polymers, soil suspending polymers, bleaching compounds, brighteners, dyes, particulates, perfume, odor control agents, hydrotropes, foam suppressors, fabric care agents, pH adjusting agents, dye transfer inhibiting agents, preservatives, synthetic detergents, organic extracts, or non-fabric dyes. In one aspect, the enzyme is selected from at least one of proteases, amylases, cellulases, or lipases. In another aspect, the composition further comprises at least one of antibiotic agents, antifungal agents, antihelminthic agents, preservatives, anti-viral agents, anti-tarnish agents, pigments, dyes, fillers, germicides, hydrotropes, anti-oxidants, pro-perfumes, aldehydes, ketones, esters and alcohols, carriers, processing aids, solvents, anti-abrasion agents, cationic surfactants, amphoteric surfactants, zwitterionic surfactants, thixotropic agents, or thickeners. In another aspect, the synthetic detergent is selected from at least one of arachidic, behenic, caproleic, dodecenoic, eicosenoic, erucic, lauric, myristic, octadecenoic, oleic, palmitic, stearic, or tetradecenoic acids or salts thereof. In another aspect, the one or more enzyme stabilizer is selected from at least one of boric acid, calcium, short chain carboxylic acids, fructose, glucose, polyhydroxyl compounds, propylene glycol, sorbitol, or sucrose. In another aspect, the method further comprises adding a base in an amount sufficient to bring the composition to a pH of 9 to 10. In another aspect, the composition has less than 0.5, 1, 2, 3, 4, 5, 6, 7, 8, 9, 10%, 15%, 20%, 25%, 30%, 35%, 40%, 45%, or 50% water per volume. In another aspect, the composition dissolves in water in less than 5, 10, 15, 20, 30, 45, 50, 60 minutes, or 1, 2, 3, 4, 5, 6, 7, 8, 9, 10, 11, 12 hours at ambient temperature. In another aspect, the composition further comprises a co-solvent including water. In another aspect, the co-solvent is at least one of Phenol-2EO, Phenol 1-20EO, C₁₋₄ phenol 1-20 EO ethoxylates, C₁₋₆ linear or branched alcohols, C₁₋₆ linear or branched 0-5PO 1-20 EO alkoxyalcohols, isobutanol 1-20EO ethoxylates, amine 1-20 EO ethoxylates, or C₁₋₆ alkyl amine 1-20 ethoxylates. In another aspect, the co-solvent serves as the medium for neutralizing sulfonate or sulfate produced in the acidic form, thereby eliminating the need to a high concentration of water to keep the neutralized surfactant flowable. In another aspect, the composition does not go through a gel-phase when dissolving in water. In another aspect, the base is at least one of NaOH, KOH, NH₄OH, Na₂CO₃, NaHCO₃, K₂CO₃, KHCO₃, Ca(OH)₂, Mg(OH)₂, Na acetate, K acetate, or NH₄ acetate. In another aspect, the base is at between about 0%, 1%, 2%, 3%, 4%, 5%, 6%, 7%, 8% volume based upon volume of the composition. In another aspect, the carboxylate is at least one of a C₂₈-25PO-45EO-carboxylate, other C₈₋₃₂2-50PO 2-100EO carboxylates, TSP 2-50PO 2-100EO carboxylates, C₈₋₃₂2-50PO carboxylates C₈₋₃₂2-100EO carboxylates, Coco amidopropylbetain, other C₁₂₋₂₀ betains or sultains. In another aspect, the sulfate is at least one of TSP-35PO-20EO sulfate, TSP 2-50PO 2-100EO sulfate or other mono-, di-, and trialkylphenolalkoxysulfates, C₁₃⁻13 PO-Sulfate, C₁₀₋₁₂-2.5EO-Sulfate, other C₈₋₃₂2-50PO 2-100EO sulfates, C₈₋₃₂ 2-50PO sulfates, or C₈₋₁₈1-50EO sulfates. In another aspect, the sulfonate is dodecylbenzenesulfonic acid or sulfonate, other C₁₀₋₂₀ alkylbenzenesulfonic acids or sulfonates, olefin sulfonate such as C₁₂₋₃₀ internal olefin sulfonates (IOS), C₁₂₋₂₀ alpha-olefin sulfonates (AOS), C₁₂₋₂₈ glycerol sulfonates, C₁₂₋₂₈ diphenyloxidedisulfonate. In another aspect, the surfactant is at least one of C₁₅₋₁₇ alkyl benzene sulfonic acid, C₁₅₋₁₈ internal olefin sulfonate, C₁₉₋₂₈ internal olefin sulfonate, C₁₉₋₂₃ internal olefin sulfonate, or C₁₂₋₂₀ alpha-olefin sulfonates. In another aspect, the neat carboxylate, sulfonate or sulfate is at between 15% volume and 75%, 20% to 70%, 30% to 60%, 40% to 50%, 15%, 16%, 17%, 18%, 19%, 20%, 25%, 30%, 35%, 40%, 45%, 50%, 55%, 60%, 65%, or 70% volume based upon total volume of the composition. In another aspect, the composition has a viscosity at 25° C. of between at least one of <300 to 10,500 at 100s−1, 400 and 10,000, 500 to 9,500, 600 to 9,000, 700 to 8,000, 800 to 7,000, 900 to 6,000, 1,000 to 5,000, 1,500 to 4,500, 2,000 to 4,000, or about 300, 321, 350, 375, 400, 450, 500, 600, 700, 750, 800, 900, 1,000, 1,100, 1,200, 1,300, 1,400, 1,500, 1,600, 1,700, 1,800, 1,900, 2,000, 2,500, 3,000, 4,000, 4,500, 5,000, 5,500, 6,000, 7,000, 8,000, 9,000, 10,000, or 10,500.

Yet another embodiment the present invention includes a method for cleaning comprising: obtaining at least one of a neat carboxylate, a neat sulfonate, or a neat sulfate heated to 30° C. or greater, wherein the neat carboxylate, the neat sulfonate, or the neat sulfate is a solid or a viscous liquid at ambient temperature; a surfactant mixed with the neat carboxylate, neat sulfonate, or neat sulfate, wherein when the mixed composition is reduced to 5° C. to 40° C. it is flowable; and one or more ingredients selected from at least one of one or more buffers, salts, corrosion protecting agents, organic solvents, enzymes, enzyme stabilizers, grease cleaning polymers, clay soil cleaning polymers, soil release polymers, soil suspending polymers, bleaching compounds, brighteners, dyes, particulates, perfume, odor control agents, hydrotropes, foam suppressors, fabric care agents, pH adjusting agents, dye transfer inhibiting agents, preservatives, synthetic detergents, organic extracts, or non-fabric dyes; diluting the composition with sufficient water to optimize cleaning; and contacting an item or location with the diluted composition under conditions in which the item or location is cleaned. In one aspect, the enzyme is selected from at least one of proteases, amylases, cellulases, or lipases. In another aspect of the method, the composition further comprises at least one of antibiotic agents, antifungal agents, antihelminthic agents, preservatives, anti-viral agents, anti-tarnish agents, pigments, dyes, fillers, germicides, hydrotropes, anti-oxidants, pro-perfumes, aldehydes, ketones, esters and alcohols, carriers, processing aids, solvents, anti-abrasion agents, cationic surfactants, amphoteric surfactants, zwitterionic surfactants, thixotropic agents, or thickeners. In another aspect, the synthetic detergents is selected from at least one of arachidic, behenic, caproleic, dodecenoic, eicosenoic, erucic, lauric, myristic, octadecenoic, oleic, palmitic, stearic, or tetradecenoic acids or salts thereof. In another aspect, the one or more enzyme stabilizer is selected from at least one of boric acid, calcium, short chain carboxylic acids, fructose, glucose, polyhydroxyl compounds, propylene glycol, sorbitol, or sucrose. In another aspect, no water is added to the composition.

### BRIEF DESCRIPTION OF THE DRAWINGS

For a more complete understanding of the features and advantages of the present invention, reference is now made to the detailed description of the invention along with the accompanying figures and in which:

FIG. 1 shows a graph of the viscosity measurement for the 87% stock versus temperature.

FIGS. 2A to 2C show the differences between the stock solution. FIG. 2A shows the IOS mixture at room temperature before mixing, FIG. 2B shows the IOS mixture at 70° C., and FIG. 2C shows the IOS carboxylate mixture at 70° C.

FIG. 3A shows a 50% surfactant blend after 5 hours, while FIGS. 3B and 3C show the 30% surfactant blend at 5 minutes and 5 hours respectively.

FIGS. 4A to 4C compare the solubility of 5% surfactant in deionized water at room temperature (25° C.) using a 87% surfactants blend (FIG. 4A), using neat TSP-35PO-20EO sulfate (FIG. 4B), and using C₁₅₋₁₇ ABS in acid form (91.1% active) (FIG. 4C) after 4 minutes mixing.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

In the chemical industry, it is highly desirable to ship materials in “neat” or high active and easily flowable form at ambient temperatures, thereby avoiding shipment of vast quantities of water in aqueous solutions. This is especially true when surfactants are shipped over distances. The present inventors have discovered, surprisingly, a unique method of producing highly active surfactant blends that are quite flowable at low temperature and which can be diluted with water with much ease in overcoming “Gelling” issues which are well known to happen when one tries to add individual surfactants to water. Surfactant blends as highly active as 85% have been easily prepared and used in alkaline-surfactant-polymer (ASP) formulations deriving all the benefits including easier solubility in water. Currently, surfactants after manufacture are prepared as 20-30% active solutions and quite often, the higher molecular weight ones are either dispersions or pastes.

As used herein the following abbreviations are used: alkaline-surfactant-polymer (ASP); internal olefin sulfonate (IOS); polypropylene oxide groups (PO); polyethylene oxide groups (EO); and Tristyrylphenol (TSP).

The detergent preparations of the present invention includes one or more ingredients selected from at least one of one or more buffers, salts, corrosion protecting agents, organic solvents, enzymes, enzyme stabilizers, grease cleaning polymers, clay soil cleaning polymers, soil release polymers, soil suspending polymers, bleaching compounds, brighteners, dyes, particulates, perfume, odor control agents, hydrotropes, foam suppressors, fabric care agents, pH adjusting agents, dye transfer inhibiting agents, preservatives, synthetic detergents, organic extracts, or non-fabric dyes. When including an enzyme it may be selected from, e.g., one or more proteases, amylases, cellulases, or lipases.

In certain formulations, the present invention may also include one or more antibiotic agents, antifungal agents, antihelminthic agents, preservatives, anti-viral agents, anti-tarnish agents, pigments, dyes, fillers, germicides, hydrotropes, anti-oxidants, pro-perfumes, aldehydes, ketones, esters and alcohols, carriers, processing aids, solvents, anti-abrasion agents, cationic surfactants, amphoteric surfactants, zwitterionic surfactants, thixotropic agents, or thickeners. When using a synthetic detergent in the formulation, non-limiting examples of the same include, e.g., arachidic, behenic, caproleic, dodecenoic, eicosenoic, erucic, lauric, myristic, octadecenoic, oleic, palmitic, stearic, or tetradecenoic acids or salts thereof. In certain formulations that includes enzymes, the formulation may also include one or more enzyme stabilizer is selected from at least one of boric acid, calcium, short chain carboxylic acids, fructose, glucose, polyhydroxyl compounds, propylene glycol, sorbitol, or sucrose.

The term “polymer” refers to a molecule having a structure that essentially includes the multiple repetitions of units derived, actually or conceptually, from molecules of low relative molecular mass. The term “polymer” includes “oligomer”.

The term “bonded” refers to having at least one of covalent bonding, hydrogen bonding, ionic bonding, Van der Waals interactions, pi interactions, London forces, or electrostatic interactions.

As used herein, the term “viscosity” refers to a fluid's internal resistance to flow or being deformed by shear or tensile stress. Viscosity may also be defined as thickness or internal friction of a liquid. Thus, in terms of viscosity it is common to think of water as having a “thin” or lower viscosity, while oil has a “thick” or higher viscosity. Generally, the less viscous a fluid is, the greater its ease of fluidity.

Examples for Preparation of High Concentration Surfactants blends.

Various combinations of surfactants were tested related to both EOR and detergent industry applications. There are three main surfactant mixing categories. (1) Mixing all neat materials (e.g., Carboxylate and alkyl benzene sulfonic acid (ABS), Sulfate and ABS, or Surfactant and Co-solvent); (2) mixing neat material with aqueous material (e.g., Neat Carboxylate and internal olefin sulfonate (IOS) aqueous solution; Sulfate and IOS solution; or Detergent range sulfate, ABS and Betain); and (3) adding excess water to make high concentration aqueous solutions (e.g., Detergent range Sulfate and ABS).

In certain examples, the compositions include: Various combinations of surfactants, e.g., mixtures of C8-32 2-50PO2-100EOSulfate and C10-20Alkyl benzene sulfonic acid (ABS); mixtures of 2-50PO 2-100EO carboxylate and Alkyl benzene sulfonic acid (ABS), mixtures of C8-32 2-50PO 2-100EO Sulfate and internal olefin sulfonate (IOS); mixtures of ABS and Co-solvent; mixtures of alkyl POSulfate and Alkyl benzene sulfonic acid (ABS); mixtures of alkyl POSulfate, Alkyl benzene sulfonic acid (ABS), and Co-solvent; mixtures of C8-32 2-50PO 2-100EOCarboxylate and IOS; mixtures of alkyl EOSulfate and Alkyl benzene sulfonic acid (ABS)(Detergent range surfactant); and mixtures alkyl Ether sulfate, Alkyl benzene sulfonic acid and Betain (Detergent range surfactant).

The mixing temperature depends on the melting point of the surfactant. Some surfactants are solid or viscous at room temperature. The mixing temperature was decided according to the type of surfactant.

The concentration of the surfactant blend depends on the concentration or the activity level of the surfactant. The blend depends on the viscosity and activity of the mixing surfactant and the available heating facility at the place that these blends will be used. Higher activity can make higher concentration surfactants. Some higher concentration blends cannot be poured at room temperature. If the heating facilities are not available, mixtures with low viscosities and low concentrations can be made.

If the surfactants being mixed do not flow at room temperature, the mixture was heated and mixed until it became homogeneous and flowable.

The use of a base, such as NaOH, is dependent on the surfactants being used in the experiment. If the surfactant was acidic and needed to be neutralized, NaOH was used to do so. If the surfactant such as an alkoxysulfate needs to be stabilized in the alkaline pH range, NaOH was used to do so.

All the surfactants that were used for these studies came as neat material (No water added). For EOR applications, most of the alkylalkoxy sulfates, alkylalkoxycarboxylates and ABSs are available as neat materials with high actives. Depending on the type of surfactant, the mixing procedure may vary.

### Examples 1 to 4

Mixing all the neat material.

### Example 1

mixture of C8-32 2-50PO 2-100EO Carboxylate and C10-20Alkyl benzene sulfonic acid.

The following is one method of preparing compositions of the present invention. First, the amount of 50% Sodium Hydroxide that was needed to neutralize the alkyl benzene sulfonic acid (ABS) was calculated. This solution was added into a mixing container.

The correct amount of both Carboxylate and ABS were added simultaneously into the 50% NaOH solution while it was mixing. This solution was mixed until it became homogeneous. Viscosity was measured at room temperature as well as 50° C.

### Example

Mixing of C₂₈-25PO-45EO carboxylate (heated to 75° C.) and C₁₅₋₁₇ Alkyl benzene sulfonic acid (ABS).

Total activity=85%

C₂₈-25PO-45EO-carboxylate (100% active)=42.5%

C₁₅₋₁₇ ABS (89.2% active)=47.6%

50% NaOH in DI=9.9%

All the components were added as shown above and mixed at room temperature. After 5 minutes of mixing using a stir bar a homogeneous flowable mixture was obtained.

Viscosity at 25° C.: 10270 cP at 100s⁻¹

Viscosity at 50° C.: 990 cP at 100s⁻¹

### Example 2

mixture of C8-32 2-50PO2-100EOSulfate and C10-20Alkyl benzene sulfonic acid (ABS).

The following is another method of preparing compositions of the present invention. First, the amount of 50% Sodium hydroxide needed to neutralize the alkyl benzene sulfonic acid (ABS) and make the Sodium salt out of the neat alkylalkoxy sulfate was calculated. The correct amount of 50% sodium hydroxide was mixed with the alkylalkoxy sulfate surfactant and mixed until a homogeneous solution was obtained. The corrected amount of ABS was added into the NaOH-Sulfate mixture while it was mixing. This solution was mixed until it became homogeneous. Viscosity was measured at room temperature as well as 50° C.

### Example

Mixing of Tristyrylphenol (TSP)-35PO-20EO sulfate as Ammonium salt and C₁₅₋₁₇Alkyl benzene sulfonic acid (ABS) at 30° C. Total activity=87%.

TSP-35PO-20EO sulfate (100% active)=52.2%

C₁₅₋₁₇ ABS (91.1% active)=38.2%

50% NaOH in DI=9.6%

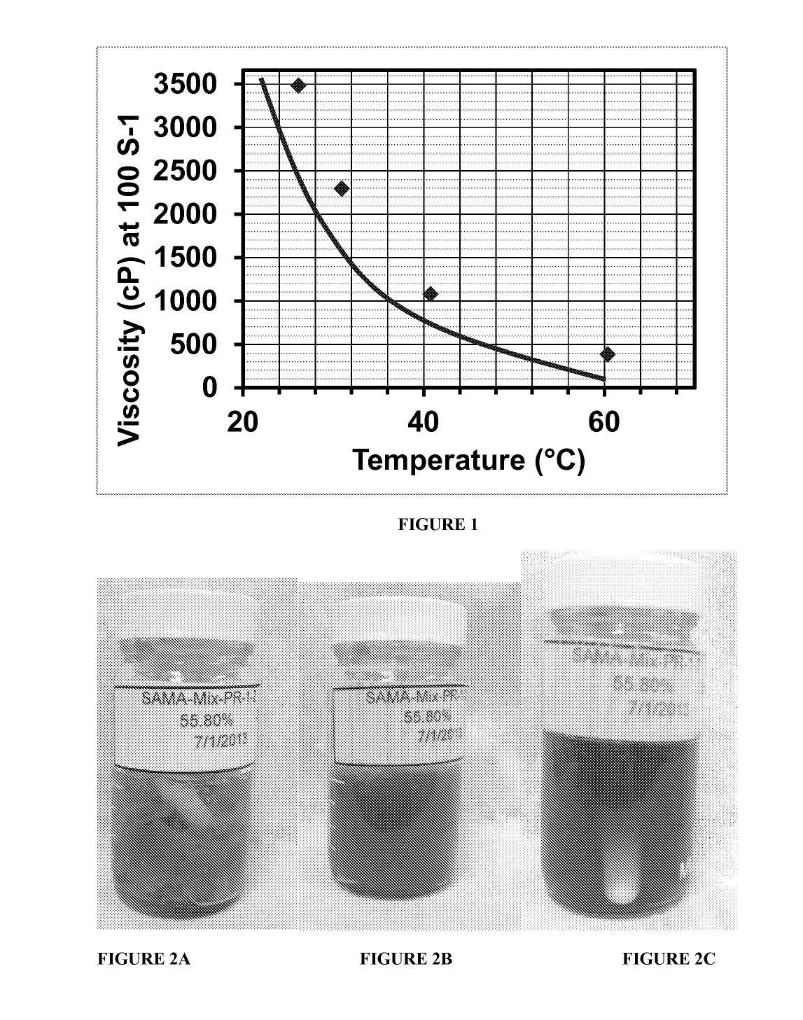

All the components were added as shown above and mixed at 30° C. After 30 minutes of mixing using a stir bar, a homogeneous flowable mixture was obtained. FIG. 1 shows a graph of the viscosity measurement for the 87% stock versus temperature.

Viscosity at 25° C.: 3500 cP at 100s⁻¹

Viscosity at 50° C.: 700 cP at 100s⁻¹

### Example 3

mixture of C8-32 2-50POSulfate and C10-20Alkyl benzene sulfonic acid (ABS).

The composition was mixed as above.

Activity=56.3% TDA-13PO-Sulfate and 20.5% ABS=Total activity of 74.5%.

C₁₃-13PO-Sulfate (78.10%)=72%

C₁₅₋₁₇ ABS (89.2%)=23%

NaOH (50%)=5%

Viscosity at 25° C.: 1708 cP at 100s⁻¹

Viscosity at 50° C.: 411.26 cP at 100s⁻¹

### Example 4

mixtures of Surfactant/Surfactants and Co-solvent.

The following is another method of preparing compositions of the present invention. The amount of 50% NaOH needed to neutralized the ABS or make the Sodium salt out of the neat alkoxy sulfate was calculated. The correct amount of 50% NaOH was dissolved in the co-solvent and then the correct amount of ABS or sulfate was added and mixed until a homogeneous solution was formed. Note that carboxylates or other surfactants that do not need to be neutralized were mixed directly with the co-solvent to get a homogeneous flowable solution.

### Example

mixture of Alkyl benzene sulfonic acid and phenol-2EO co-solvent.

Activity 48% C₁₅₋₁₇ABS in 32% Phenol-2EOCo-solvent.

C₁₅₋₁₇ ABS (89.2% active)=53.8%

Phenol-2EO (100% active)=32.0%

50% NaOH in DI=14.2%

All the components were added as shown above and mixed at room temperature. After 5 minutes of mixing using a stir bar, a homogeneous flowable mixture was obtained. The following viscosities were measured:

Viscosity at 25° C.: 562 cP at 100s⁻¹

Viscosity at 50° C.: 134 cP at 100s⁻¹

### Example

mixture of 2-50POSulfate, Alkyl benzene sulfonic acid and Co-solvent:

C₁₅₋₁₇ ABS (89.2% active)=12.9%

C₁₃-13PO-Sulfate ((78.1% active)=40.6%

Phenol-2EO (co-solvent) (100% active)=43.2%

50% NaOH in DI=3.3%

The following is another method of preparing compositions of the present invention. First the correct amount of neat Phenol-2EO co-solvent and 50% NaOH solution was mixed together till homogeneous. Then, the correct amount of neat C₁₅₋₁₇ ABS acid was added to the Co-solvent/NaOH mixture and mixed well. The correct amount of C₁₃-13PO-Sulfate was added. All the mixing was carried out at room temperature (25° C.).

After 5 minutes of mixing at 25° C. a deep honey colored, homogeneous, and flowable solution was achieved. The pH of the stock solution was around 11.00.

Surfactant activity=43.2%

Co-solvent activity=43.2%

### Example 5 to 7

Mixing neat material with aqueous material.

### Example 5

mixtures of alkylPO EO Carboxylate and IOS.

The following is another method of preparing compositions of the present invention. The correct amount of IOS and carboxylate were mixed until it produced a homogeneous solution. The solution was heated to 50° C. or higher for better mixing. Depending on the concentration and the flowability, the temperature may vary.

### Example

Total activity˜37%

C₂₈-25PO-45EO carboxylate (100%) Heated to 70° C.=16.1%

C₁₅₋₁₈IOS (28.03%)=35.4%

C₁₉₋₂₈ IOS (23%)=48.5%

First, both C₁₅₋₁₈ IOS and C₁₉₋₂₈ IOS were mixed together at 70° C. to produce a homogeneous solution. Then the heated carboxylate was added. After 5 minutes of mixing at 70° C. a homogeneous solution was obtained. This solution was flowable at room temperature. The following viscosities were measured:

Viscosity at 25° C.: 321 cP at 100s⁻¹

Viscosity at 50° C.: 70 cP at 100s⁻¹

Using the high activity IOS the above surfactant mixture of 55.8% activity was made. It showed lower viscosity and was flowable at 50° C.

C₂₈-25PO-45EO-Carboxylate (100% active)=24.2%

C₁₅₋₁₈ IOS (30.1% active)=49.5%

C₁₉₋₂₈ IOS (64% active)=26.3%

The following viscosity was measured:

Viscosity at 50° C.: 1000 cP at 100s⁻¹

FIGS. 2A to 2C show the differences between the stock solutions (2A) IOS mixture at room temperature before mixing, FIG. 2B shows the IOS mixture at 70° C., and FIG. 2C shows the IOS carboxylate mixture at 70° C.

### Example 6

mixture of C8-32 2-50PO 2-100EO Sulfate and C12-30IOS.

The following is another method of preparing compositions of the present invention. The amount of 50% NaOH that was needed to neutralized alkoxy sulfate was calculated. This was then mixed with alkoxy sulfate to produce a homogeneous solution. Then the correct amount of IOS was added to the mixture and mixed until a homogeneous solution was obtained.

### Example

TSP and IOS˜55%

TSP-35PO-20EO-Sulfate (100%) Heated to 60C=32.8%

C₁₉₋₂₃ IOS (33.0%) (Heated 60C)=66%

50% NaOH=1.2%

The correct amount of NaOH and heated TSP-35PO-20EO Sulfate was mixed together to get a homogeneous solution at 60° C. Then, heated C₁₉₋₂₃ IOS was added and mixed. After 20 minutes of mixing at 60° C., a homogeneous flowable solution was obtained. This mixture was somewhat flowable at room temperature. The following viscosities were measured:

Viscosity at 25° C.: 9787 cP at 100s⁻¹

Viscosity at 50° C.: 1348 cP at 100s⁻¹

### Example 7

mixture of AlkylEther sulfate, Alkyl benzene sulfonic acid and Betain (Detergent range surfactant)˜57%.

The following is another method of preparing compositions of the present invention. The amount of 50% NaOH solution needed to neutralize the ABS, Sulfate and Betain was calculated. The 50% NaOH and Betain solutions were mixed together at 55° C. and then the heated sulfate and ABS were added simultaneously and mixed using a rod. This solution was flowable at 55° C. and appeared as a soft paste at 25° C.

Dodecylbenzenesulfonic acid (C12 ABS) (100%)=19.2%

C₁₀₋₁₂-2.5EO-Sulfate (Heated to 55° C.) (95%)=20.2%

Coco amidopropylBetain (35.5%)=54.8%

50% NaOH=5.8%

The following viscosities were measured: Viscosity at 50° C.: 4777 cP at 100s−1.

Examples for High concentration aqueous mixture.

### Example 8

mixtures of C8-32 2-50EOSulfate and C10-20Alkyl benzene sulfonic acid (Detergent range surfactant).

The following is another method of preparing compositions of the present invention. When mixing a neat surfactant blend is difficult, making a high concentration aqueous solution is still possible. The concentration of aqueous solution is determined by the temperature that is available to handle the solution. If needed, the calculated amount of NaOH was added to the DI water and mixed. Next, the correct amount of surfactants that were to be mixed was added simultaneously to the DI water while it was mixing. The mixture was mixed until it produced a homogeneous solution.

### Example

mixture of C₁₂Alkyl benzene sulfonic acid (C₁₂ ABS) and C₁₀₋₁₂-2.5EO Sulfate.

After mixing, a neat C₁₂ ABS and C₁₀₋₁₂-2.5 Sulfate produced a high-viscous paste. As a result, an aqueous solution was made.

C₁₂ ABS (100%)=25%

C₁₀₋₁₂ 2.5 EO Sulfate (Heated to 50° C.)=26.3%

NaOH (100%)=3.2%

Deionized water (DI)=45.5%

After mixing NaOH and DI water at 50° C., the heated sulfate and ABS were added simultaneously and mixed at 50° C. After about 10 minutes mixing of mixing, a homogeneous solution was obtained and flowable at room temperature. The following viscosities were measured:

Viscosity at 15° C.: 385 cP at 100s⁻¹

Viscosity at 25° C.: 376 cP at 100s⁻¹

Viscosity at 50° C.: 349 cP 100s⁻¹

### Example

mixtures of 30% and 50% C₆₋₁₀-3EO-Sulfate and C₁₂Alkyl benzene sulfonic acid (C₁₂ ABS) surfactant blend:

Same mixing procedure was used as above. First the correct amount of NaOH solution was made by adding 100% NaOH pellets in to DI water. Then, the correct amount of neat C₆₋₁₀-3EO-sulfate and neat Dodecylbenzenesulfonic acid (C₁₂ ABS) were added simultaneously to the NaOH solution with mixing. All the mixing was carried out at room temperature.

TABLE 1
summarized the components and the weight percent for 30%
and 50% active blends.

| | Wt % for 30% | Wt % for 50% |
|---|---|---|
| Component | active blend | active blend |
| C₆₋₁₀-3EO-Sulfate (97% active) | 15.5% | 25.8% |
| C₁₂ ABS (100% active) | 15% | 25% |
| NaOH (100% active) | 3.9% | 6.5% |
| DI water | 65.6% | 42.7% |

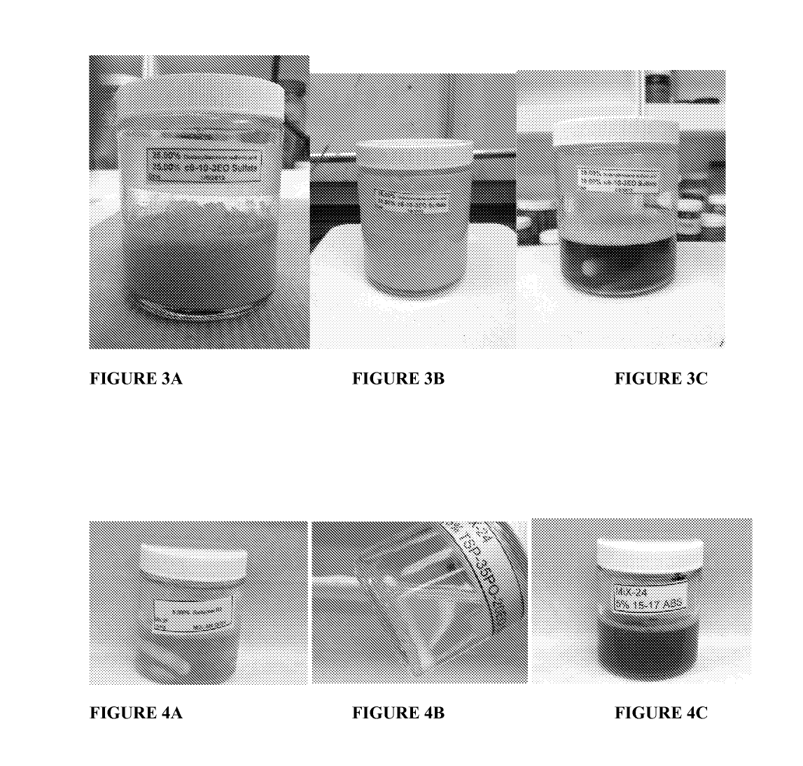

After 5 minutes of mixing at room temperature both mixtures gave a foamy, homogeneous, flowable solution. After 5 hours of standing, the 30% solution gave a clear homogeneous solution whereas the foam in the 50% flowable solution persisted. FIGS. 3B and 3C show the 30% surfactant blend at 5 minutes and 5 hours respectively, while FIG. 3A shows a 50% surfactant blend after 5 hours.

Solubility of the high active surfactant blends: Examples 9-10.

### Example 9

Dissolving 0.6% surfactants in 6% Na₂CO₃ solution using 87% active surfactant blend.

Preparation of Neat Surfactant Stock (87%) Using 50% NaOH solution. The following is another method of preparing compositions of the present invention. First correct amount of neat TSP and 50% NaOH solution was mixed together till get a homogeneous mixture. Next, the correct amount of neat C₁₅₋₁₇ ABS was added to the TSP/NaOH mixture and mixed well. All the mixing was carried out at 30° C. temperature.

TSP-35PO-20EO-Sulfate (100% active)=52.2%

C₁₅₋₁₇ ABS (91.1% active)=38.2%

50% NaOH in DI=9.6%

After 30 minutes of mixing at 30° C. a deep honey colored, homogeneous, and flowable solution was achieved. The pH of the stock solution was around 9.5.

Preparation of 0.6% Total Surfactant (2×0.3%) in a 6% Na₂CO₃ Solution using 87% Surfactant blend.

Briefly, 87% Surfactants stock was diluted in a 6% Na₂CO₃ to obtain a 0.6% surfactant solution in 6% Na₂CO₃(Surfactant stock solution was at 30° C. and 6.0% Na₂CO₃ was heated to 62° C. temperature).

87% Surfactant stock=0.69%

6% Na₂CO₃ solution=99.31%

After 2-3 minutes of mixing at 62° C. a homogeneous solution was achieved.

### Example 10

Mixing time for 5% Surfactant in DI.

The following is another method of preparing compositions of the present invention. Mixing time was measured to make 5% surfactant in DI at room temperature: (1) Using 87% Surfactants blend (Surfactant stock solution and DI water was at 25° C.); (2) Using neat TSP-35PO-20EO sulfate (100% active); and (3) Using C₁₅₋₁₇ ABS (91.1% active). After measuring surfactants and adding DI water, all three samples were placed in a same mixing plate and mixed simultaneously using same speed and measured the mixing time.

Mixing time for 5% Surfactant in DI using 87% surfactant blend was 4 minutes.

FIG. 4A to 4C compares the solubility of 5% surfactant in deionized water at room temperature (25° C.) using a 87% surfactants blend (FIG. 4A), using neat TSP-35PO-20EO sulfate (FIG. 4B), using C₁₅₋₁₇ ABS (91.1% active) (FIG. 4C) after 4 minutes mixing.

TABLE 2
summarizes the result using a mixing time for 5%
surfactant in DI and the loss of a gel phase during
the transition using the present invention.

| | Mixing time at RT | Physical appearance |
|---|---|---|
| Using 87% active stock | 4 minutes | Did not make gel |
| | | phase |
| Using neat TSP-35PO-20EO | 55 minutes | Went through gel |
| sulfate (100% active) | | phase before dissolved |
| Using 15-17 ABS (91.1% | 15 minutes | Went through gel |
| active) | (not clear) | phase before dissolved |

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 8, 9, 10, 11, 12, 13, 14, or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A neat or high concentration fluid detergent composition comprising:
at least one of a neat carboxylate, a neat sulfonate, or a neat sulfate heated to 30° C. or greater, wherein the neat carboxylate (or acid thereof), the neat sulfonate (or acid thereof), or the neat sulfate (or acid thereof) is a solid or a viscous liquid at ambient temperature;
a surfactant mixed with the neat carboxylate, neat sulfonate, or neat sulfate, wherein when the mixed composition is reduced to 5° C. to 40° C. it is flowable; and
one or more ingredients selected from at least one of one or more buffers, salts, corrosion protecting agents, organic solvents, enzymes, enzyme stabilizers, grease cleaning polymers, clay soil cleaning polymers, soil release polymers, soil suspending polymers, bleaching compounds, brighteners, dyes, particulates, perfume, odor control agents, hydrotropes, foam suppressors, fabric care agents, pH adjusting agents, dye transfer inhibiting agents, preservatives, synthetic detergents, organic extracts, or non-fabric dyes.

2. The composition of claim 1, wherein the enzyme is selected from at least one of proteases, amylases, cellulases, or lipases.

3. The composition of claim 1, wherein the composition further comprises at least one of antibiotic agents, antifungal agents, antihelminthic agents, preservatives, anti-viral agents, anti-tarnish agents, pigments, dyes, fillers, germicides, hydrotropes, anti-oxidants, pro-perfumes, aldehydes, ketones, esters and alcohols, carriers, processing aids, solvents, anti-abrasion agents, cationic surfactants, amphoteric surfactants, zwitterionic surfactants, thixotropic agents, or thickeners.

4. The composition of claim 1, wherein the synthetic detergent is selected from at least one of arachidic, behenic, caproleic, dodecenoic, eicosenoic, erucic, lauric, myristic, octadecenoic, oleic, palmitic, stearic, or tetradecenoic acids or salts thereof.

5. The composition of claim 1, wherein the one or more enzyme stabilizer is selected from at least one of boric acid, calcium, short chain carboxylic acids, fructose, glucose, polyhydroxyl compounds, propylene glycol, sorbitol, or sucrose.

6. The composition of claim 1, further comprising a base in an amount sufficient to bring the composition to a pH of 9 to 10.

7. The composition of claim 1, wherein the composition has less than 0.5, 1, 2, 3, 4, 5, 6, 7, 8, 9, 10%, 15%, 20%, 25%, 30%, 35%, 40%, 45%, or 50% water per volume.

8. The composition of claim 1, wherein the composition dissolves in water in less than 5, 10, 15, 20, 30, 45, 50, 60 minutes, or 1, 2, 3, 4, 5, 6, 7, 8, 9, 10, 11, 12 hours at ambient temperature.

9. The composition of claim 1, wherein the composition further comprises a co-solvent including water.

10. The composition of claim 9, wherein the co-solvent is at least one of Phenol-2EO, phenol 1-20 EO, C1-4 phenol ethoxylates, C₁₋₆ linear or branched alcohols, C₁₋₆ linear or branched 0-5PO 1-20EO alkoxyalcohols, isobutanol 1-20 EO ethoxylates, amine 1-20EO ethoxylates, or C₁₋₆ alkyl amine 1-20ethoxylates.

11. The composition in claim 10, wherein the co-solvent serves as the medium for neutralizing sulfonate or sulfate produced in the acidic form, thereby eliminating the need to a high concentration of water to neutralize and keep the neutralized surfactant flowable.

12. The composition of claim 1, wherein the composition does not go through a gel-phase when dissolving in water.

13. The composition of claim 1, wherein the base is at least one of NaOH, KOH, NH₄OH, Na₂CO₃, NaHCO₃, K₂CO₃, KHCO₃, Ca(OH)₂, Mg(OH)₂, Na acetate, K acetate, or NH₄ acetate.

14. The composition of claim 1, wherein the base is at between about 0%, 1%, 2%, 3%, 4%, 5%, 6%, 7%, 8% volume based upon volume of the composition.

15. The composition of claim 1, wherein the carboxylate is at least one of a C₂₈-25PO-45EO-carboxylate, other C₈₋₃₂ 2-50PO 2-100EO carboxylates, TSP 2-50PO 2-100EO carboxylates, C8-32 2-50PO carboxylates C₈₋₃₂ 2-100EO carboxylates, C₈₋₁₈ carboxylates, Coco amidopropylbetain, other C₁₂₋₂₀betains or sultains.

16. The composition of claim 1, wherein the sulfate is at least one of TSP-35PO-20EO sulfate or TSP 2-50PO 2-100EO sulfate, or other mono-, di-, and trialkylphenolalkoxysulfates, C_{13 13}PO-Sulfate, C₁₀₋₁₂-2.5EO-Sulfate, other C₈₋₃₂ 2-50PO 2-100EO sulfates, C₈₋₃₂ 2-50PO sulfates, or C₈₋₁₈2-100EO sulfates.

17. The composition of claim 1, wherein the sulfonate is dodecylbenzenesulfonic acid or sulfonate, C₁₀₋₂₀ alkylbenzenesulfonic acid or sulfonate, olefin sulfonate such as C₁₂₋₃₀ internal olefin sulfonates (IOS), C12-20 alpha-olefin sulfonates (AOS), C₁₂₋₂₈ glycerol sulfonates, C₁₂₋₂₈ diphenyloxidedisulfonate.

18. The composition of claim 1, wherein the surfactant is at least one of C₁₅₋₁₇ alkyl benzene sulfonic acid, C₁₅₋₁₈ internal olefin sulfonate, 19-28 internal olefin sulfonate, C₁₉₋₂₃ internal olefin sulfonate, or C₁₂₋₂₀ alpha-olefin sulfonates.

19. The composition of claim 1, wherein the neat carboxylate, sulfonate or sulfate is at between 15% volume and 75%, 20% to 70%, 30% to 60%, 40% to 50%, 15%, 16%, 17%, 18%, 19%, 20%, 25%, 30%, 35%, 40%, 45%, 50%, 55%, 60%, 65%, or 70% volume based upon total volume of the composition.

20. The composition of claim 1, wherein the composition has a viscosity at 25° C. of between at least one of <300 to 10,500 at 100s⁻¹, 400 and 10,000, 500 to 9,500, 600 to 9,000, 700 to 8,000, 800 to 7,000, 900 to 6,000, 1,000 to 5,000, 1,500 to 4,500, 2,000 to 4,000, or about 300, 321, 350, 375, 400, 450, 500, 600, 700, 750, 800, 900, 1,000, 1,100, 1,200, 1,300, 1,400, 1,500, 1,600, 1,700, 1,800, 1,900, 2,000, 2,500, 3,000, 4,000, 4,500, 5,000, 5,500, 6,000, 7,000, 8,000, 9,000, 10,000, or 10,500.

21. A method of making a high active or neat, flowable surfactant composition for use in detergent and cleaning applications comprising the steps of:
mixing with a surfactant at least one of a neat carboxylate, a neat sulfonate (or acid thereof), or a neat sulfate, wherein the components are solid or viscous at ambient temperature;
heating the mixture to 30° C. or greater to form the mixture, wherein when the mixture is at 5° C. to 40° C. it is flowable; and
adding one or more ingredients selected from at least one of one or more buffers, salts, corrosion protecting agents, organic solvents, enzymes, enzyme stabilizers, grease cleaning polymers, clay soil cleaning polymers, soil release polymers, soil suspending polymers, bleaching compounds, brighteners, dyes, particulates, perfume, odor control agents, hydrotropes, foam suppressors, fabric care agents, pH adjusting agents, dye transfer inhibiting agents, preservatives, synthetic detergents, organic extracts, or non-fabric dyes.

22. The method of claim 21, wherein the enzyme is selected from at least one of proteases, amylases, cellulases, or lipases.

23. The method of claim 21, wherein the composition further comprises at least one of antibiotic agents, antifungal agents, antihelminthic agents, preservatives, anti-viral agents, anti-tarnish agents, pigments, dyes, fillers, germicides, hydrotropes, anti-oxidants, pro-perfumes, aldehydes, ketones, esters and alcohols, carriers, processing aids, solvents, anti-abrasion agents, cationic surfactants, amphoteric surfactants, zwitterionic surfactants, thixotropic agents, or thickeners.

24. The method of claim 21, wherein the synthetic detergents is selected from at least one of arachidic, behenic, caproleic, dodecenoic, eicosenoic, erucic, lauric, myristic, octadecenoic, oleic, palmitic, stearic, or tetradecenoic acids or salts thereof.

25. The method of claim 21, wherein the one or more enzyme stabilizer is selected from at least one of boric acid, calcium, short chain carboxylic acids, fructose, glucose, polyhydroxyl compounds, propylene glycol, sorbitol, or sucrose.

26. The method of claim 21, further comprising a base in an amount sufficient to bring the composition to a pH of 9 to 10.

27. The method of claim 21, wherein the composition has less than 0.5, 1, 2, 3, 4, 5, 6, 7, 8, 9, 10%, 15%, 20%, 25%, 30%, 35%, 40%, 45%, or 50% water per volume.

28. The method of claim 21, wherein the composition dissolves in water in less than 5, 10, 15, 20, 30, 45, 50, 60 minutes, or 1, 2, 3, 4, 5, 6, 7, 8, 9, 10, 11, 12 hours at ambient temperature.

29. The method of claim 21, wherein the composition further comprises a co-solvent including water.

30. The method of claim 29, wherein the co-solvent is at least one of Phenol-2EO, other phenol 1-20 EO, C₁₋₄phenol 1-20 EO ethoxylates, C₁₋₆ linear or branched alcohols, C₁₋₆ linear or branched 0-5PO 1-20EO alkoxyalcohols, isobutanol 1-20EO ethoxylates, amine 1-20EO ethoxylates, or C₁₋₆ alkyl amine 1-20EO ethoxylates.

31. The method of claim 21, wherein the co-solvent serves as the medium for neutralizing sulfonate or sulfate produced in the acidic form, thereby eliminating the need to a high concentration of water to keep the neutralized surfactant flowable.

32. The method of claim 21, wherein the composition does not go through a gel-phase when dissolving in water.

33. The method of claim 21, wherein the base is at least one of NaOH, KOH, NH₄OH, Na₂CO₃, NaHCO₃, K₂CO₃, KHCO₃, Ca(OH)₂, Mg(OH)₂, Na acetate, K acetate, or NH₄ acetate.

34. The method of claim 21, wherein the base is at between about 0%, 1%, 2%, 3%, 4%, 5%, 6%, 7%, 8% volume based upon volume of the composition.

35. The method of claim 21, wherein the carboxylate is at least one of a C₂₈-25PO-45EO-carboxylate, other C₁₂₋₃₂ 2-50PO 2-100EO carboxylates, TSP 2-50PO 2-100EO carboxylates, C8-32 2-50PO carboxylates C₈₋₃₂ 2-100EO carboxylates, C₈₋₁₈ carboxylates, Coco amidopropylbetain, other C₁₂₋₂₀betains or sultains.

36. The method of claim 21, wherein the sulfate is at least one of TSP-35PO-20EO sulfate or TSP 2-50PO 2-100EO sulfate, or other mono-, di-, and trialkylphenolalkoxysulfates, C_{13 13}PO-Sulfate, C₁₀₋₁₂-2.5EO-Sulfate, other C₈₋₃₂ 2-50PO 2-100EO sulfates, C₈₋₃₂ 2-50PO sulfates, or C₈₋₁₈2-100EO sulfates.

37. The method of claim 21, wherein the sulfonate is dodecylbenzenesulfonic acid or sulfonate, C₁₀₋₂₀ alkylbenzenesulfonic acid or sulfonate, olefin sulfonate such as C₁₂₋₃₀ internal olefin sulfonates (IOS), C12-20 alpha-olefin sulfonates (AOS), C₁₂₋₂₈ glycerol sulfonates, C₁₂₋₂₈ diphenyloxidedisulfonate.

38. The method of claim 21, wherein the surfactant is at least one of C₁₅₋₁₇ alkyl benzene sulfonic acid, C₁₅₋₁₈ internal olefin sulfonate, 19-28 internal olefin sulfonate, C₁₉₋₂₃ internal olefin sulfonate, or C₁₂₋₂₀ alpha-olefin sulfonates.

39. The method of claim 21, wherein the neat carboxylate, sulfonate or sulfate is at between 15% volume and 75%, 20% to 70%, 30% to 60%, 40% to 50%, 15%, 16%, 17%, 18%, 19%, 20%, 25%, 30%, 35%, 40%, 45%, 50%, 55%, 60%, 65%, or 70% volume based upon total volume of the composition.

40. The method of claim 21, wherein the composition has a viscosity at 25° C. of between at least one of <300 to 10,500 at 100s⁻¹, 400 and 10,000, 500 to 9,500, 600 to 9,000, 700 to 8,000, 800 to 7,000, 900 to 6,000, 1,000 to 5,000, 1,500 to 4,500, 2,000 to 4,000, or about 300, 321, 350, 375, 400, 450, 500, 600, 700, 750, 800, 900, 1,000, 1,100, 1,200, 1,300, 1,400, 1,500, 1,600, 1,700, 1,800, 1,900, 2,000, 2,500, 3,000, 4,000, 4,500, 5,000, 5,500, 6,000, 7,000, 8,000, 9,000, 10,000, or 10,500.

41. A method for cleaning composition comprising:
obtaining at least one of a neat carboxylate, a neat sulfonate, or a neat sulfate heated to 30° C. or greater, wherein the neat carboxylate, the neat sulfonate, or the neat sulfate is a solid or a viscous liquid at ambient temperature;
a surfactant mixed with the neat carboxylate, neat sulfonate, or neat sulfate, wherein when the mixed composition is reduced to 5° C. to 40° C. it is flowable; and
one or more ingredients selected from at least one of one or more buffers, salts, corrosion protecting agents, organic solvents, enzymes, enzyme stabilizers, grease cleaning polymers, clay soil cleaning polymers, soil release polymers, soil suspending polymers, bleaching compounds, brighteners, dyes, particulates, perfume, odor control agents, hydrotropes, foam suppressors, fabric care agents, pH adjusting agents, dye transfer inhibiting agents, preservatives, synthetic detergents, organic extracts, or non-fabric dyes;
diluting the composition with sufficient water to optimize cleaning; and
contacting an item or location with the diluted composition under conditions in which the item or location is cleaned.

42. The method of claim 41, wherein the enzymes is selected from at least one of proteases, amylases, cellulases, or lipases.

43. The method of claim 41, wherein the composition further comprises at least one of antibiotic agents, antifungal agents, antihelminthic agents, preservatives, anti-viral agents, anti-tarnish agents, pigments, dyes, fillers, germicides, hydrotropes, anti-oxidants, pro-perfumes, aldehydes, ketones, esters and alcohols, carriers, processing aids, solvents, anti-abrasion agents, cationic surfactants, amphoteric surfactants, zwitterionic surfactants, thixotropic agents, or thickeners.

44. The method of claim 41, wherein the synthetic detergents is selected from at least one of arachidic, behenic, caproleic, dodecenoic, eicosenoic, erucic, lauric, myristic, octadecenoic, oleic, palmitic, stearic, or tetradecenoic acids or salts thereof.

45. The method of claim 41, wherein the one or more enzyme stabilizer is selected from at least one of boric acid, calcium, short chain carboxylic acids, fructose, glucose, polyhydroxyl compounds, propylene glycol, sorbitol, or sucrose.

46. The method of claim 41, wherein no water is added to the composition.
